(19) United States
(12) Patent Application Publication
(10) Pub. No.: US 2015/0349319 A1
(43) Pub. Date: Dec. 3, 2015

(54) RECHARGEABLE BATTERY HAVING A PLATE TERMINAL

(71) Applicant: Samsung SDI Co., Ltd., Yongin-si (KR)

(72) Inventor: Ki-Hyun KIM, Yongin-si (KR)

(21) Appl. No.: 14/721,491

(22) Filed: May 26, 2015

(30) Foreign Application Priority Data
May 27, 2014 (KR) 10-2014-0063901

(51) Int. Cl. H01M 2/30; H01M 2/04; H01M 2/06

(52) U.S. Cl. CPC H01M 2/30; H01M 2/06; H01M 2/0456; H01M 2/0486

(57) ABSTRACT

Provided is a rechargeable battery including an electrode assembly including a first electrode and a second electrode; a case in which the electrode assembly is mounted; a cap plate coupled to the case; and a terminal electrically connected to the first electrode and protruding to an outside of the cap plate. The terminal includes a die-cast plate terminal and a pillar terminal inserted into the plate terminal, the plate terminal being formed of an aluminum alloy containing 1.0 wt % or less of copper (Cu), 11.0-13.0 wt % of silicon (Si), 0.3 wt % or less of magnesium (Mg), 0.5 wt % or less of zinc (Zn), 1.3 wt % or less of iron (Fe), 0.3 wt % or less of manganese (Mn), 0.5 wt % or less of nickel (Ni), 0.30 wt % or less of titanium (Ti), 0.20 wt % or less of lead (Pb), and 0.1 wt % or less of tin (Sn).

### CROSS-REFERENCE TO RELATED APPLICATION

Korean Patent Application No. 10-2014-0063901 filed on May 27, 2014, in the Korean Intellectual Property Office, and entitled: “Rechargeable Battery Having Plate Terminal,” is incorporated by reference herein in its entirety.

### BACKGROUND

1. Field

Provided is a rechargeable battery, and more particularly, to a rechargeable battery including a plate terminal.

2. Description of the Related Art

A rechargeable battery may be repeatedly charged and discharged, unlike a primary battery, which may not be recharged. A low capacity rechargeable battery may be used for a small portable electronic device such as a mobile phone, a laptop computer, or a camcorder, and a large capacity battery may be used as a power source for driving a motor of, for example, a hybrid vehicle.

### SUMMARY

Embodiments may be realized by providing a rechargeable battery including an electrode assembly including a first electrode and a second electrode; a case in which the electrode assembly is mounted; a cap plate coupled to the case; and a terminal electrically connected to the first electrode and protruding to an outside of the cap plate. The terminal includes a die-cast plate terminal and a pillar terminal inserted into the plate terminal, the plate terminal being formed of an aluminum alloy containing 1.0 wt % or less of copper (Cu), 11.0-13.0 wt % of silicon (Si), 0.3 wt % or less of magnesium (Mg), 0.5 wt % or less of zinc (Zn), 1.3 wt % or less of iron (Fe), 0.3 wt % or less of manganese (Mn), 0.5 wt % or less of nickel (Ni), 0.30 wt % or less of titanium (Ti), 0.20 wt % or less of lead (Pb), and 0.1 wt % or less of tin (Sn).

A melting point of the aluminum alloy may range from 573 to 582° C.

An impact strength of the aluminum alloy may range from 75 to 84 kJ/m².

An impact strength of the aluminum alloy may be 79 kJ/m².

A shear strength of the aluminum alloy may range from 160 to 180 MPa.

A fatigue strength of the aluminum alloy may range from 120 to 140 MPa.

The cap plate may be a die-cast cap plate.

The cap plate may be formed of an aluminum alloy containing 1.0 wt % or less copper (Cu), 11.0-13.0 wt % of silicon (Si), 0.3 wt % or less of magnesium (Mg), 0.5 wt % or less of zinc (Zn), 1.3 wt % or less of iron (Fe), 0.3 wt % or less of manganese (Mn), 0.5 wt % or less of nickel (Ni), 0.30 wt % or less of titanium (Ti), 0.20 wt % or less of lead (Pb), and 0.1 wt % or less of tin (Sn).

A screw thread may be formed at an upper portion of the pillar terminal, and the pillar terminal may be manufactured by a drawing process.

The pillar terminal may be fixedly riveted to the plate terminal and may be a die-cast pillar terminal.

The pillar terminal may be formed of an aluminum alloy containing 1.0 wt % or less of copper (Cu), 11.0-13.0 wt % of silicon (Si), 0.3 wt % or less of magnesium (Mg), 0.5 wt % or less of zinc (Zn), 1.3 wt % or less of iron (Fe), 0.3 wt % or less of manganese (Mn), 0.5 wt % or less of nickel (Ni), 0.30 wt % or less of titanium (Ti), 0.20 wt % or less of lead (Pb), and 0.1 wt % or less of tin (Sn).

### BRIEF DESCRIPTION OF THE DRAWINGS

Features will become apparent to those of skill in the art by describing in detail exemplary embodiments with reference to the attached drawings in which:

FIG. 1 illustrates a perspective view of a rechargeable battery according to a first exemplary embodiment.

FIG. 2 illustrates a cross-sectional view taken along the line II-II of FIG. 1.

FIG. 3 illustrates a perspective view showing a cap plate of the rechargeable battery according to a first exemplary embodiment.

FIG. 4 illustrates a perspective view showing a plate terminal of the rechargeable battery according to a first exemplary embodiment.

FIG. 5 illustrates a perspective view showing a rechargeable battery according to a second exemplary embodiment.

FIG. 6 illustrates a cross-sectional view taken along the line VI-VI of FIG. 5.

FIG. 7 illustrates an exploded perspective view of a plate terminal and a pillar terminal according to a second exemplary embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. In the drawings and this specification, the same or like constituent elements are designated by the same reference numerals throughout the specification.

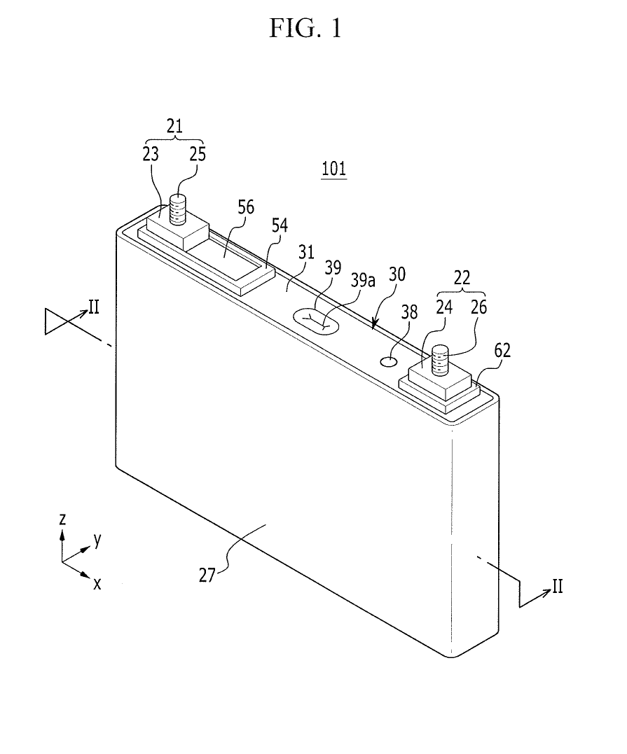

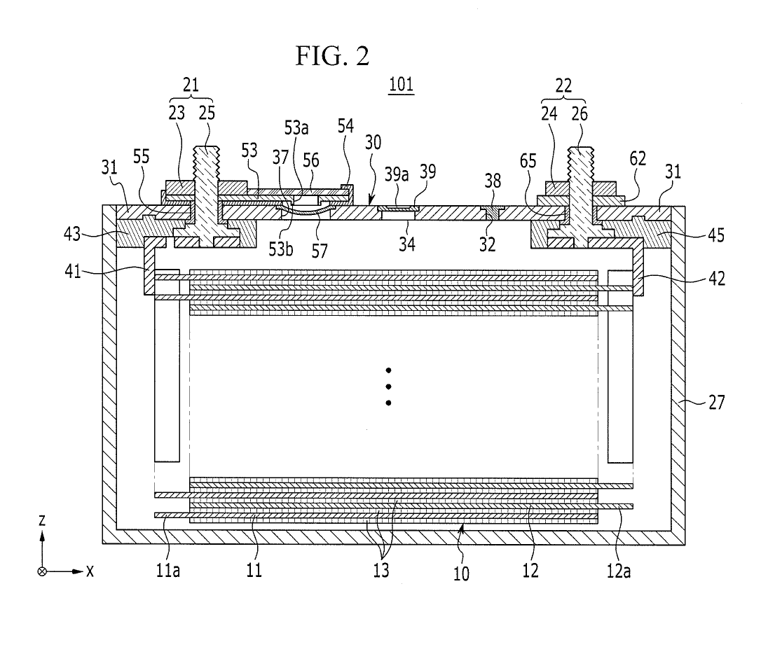

FIG. 1 illustrates a perspective view of a rechargeable battery according to a first exemplary embodiment, and FIG. 2 is a cross-sectional view taken along the line II-II of FIG. 1.

Referring to FIG. 1 and FIG. 2, a rechargeable battery 101 in accordance with a first exemplary embodiment may includes an electrode assembly 10 formed by winding a positive electrode 11 and a negative electrode 12 while interposing a separator 13 therebetween, a case 27 in which the electrode assembly 10 may be mounted, and a cap assembly 30 that may be coupled to an opening of the case 27.

The rechargeable battery 101 is illustrated as a lithium ion rechargeable battery formed in the shape of a cuboid. In embodiments, provided are various types of batteries including a lithium polymer battery or a cylindrical battery.

The positive electrode (first electrode) 11 and the negative electrode (second electrode) 12 may include coated regions where an active material may be coated to a current collector formed of a thin metal foil, and uncoated regions 11a and 12a where the active material may not be coated. The positive electrode uncoated region 11a may be formed at one end of the positive electrode 11 along a length direction of the positive electrode 11, and the negative uncoated region 12a may be formed at one end of the negative electrode 12 along a length direction of the negative electrode 12. The positive electrode uncoated region 11a and the negative uncoated region 12a may be formed at opposite ends of the electrode assembly 10. The positive electrode 11 and the negative electrode 12 may be spirally wound, interposing the separator 13, which may be an insulator therebetween.

In an embodiment, the electrode assembly 10 may have a structure in which a plurality of positive electrodes and negative electrodes formed in a sheet shape may be stacked while interposing a separator therebetween.

The case 27 may be formed as an approximate cuboid, and an opening may be formed on a side thereof. The case 26 may be made of a metal such as, for example, aluminum or stainless steel.

The cap assembly 30 may include a cap plate 31 covering the opening of the case 27, a first terminal 21 protruding toward the outside of the cap plate 31 and electrically connected to the positive electrode 11, and a second terminal 22 protruding toward the outside of the cap plate 31 and electrically connected to the negative electrode 12.

The first terminal 21 and the second terminal 22 may be mounted to protrude toward an upper portion of the cap plate 31. The first terminal 21 may be electrically connected to the negative electrode 12 through a current collecting tab 42, and the second terminal 22 may be electrically connected to the positive electrode 11 through a current collecting tab 41. In an embodiment, the first terminal 21 may be electrically connected to the positive electrode 11 and the second terminal 22 may be electrically connected to the negative electrode 12.

The first terminal 21 may include a plate terminal 23 that may be exposed to the outside, and a pillar terminal 25 that may be mounted to extend through the plate terminal 23 and adhered to the current collecting tab 41

The plate terminal 23 may be formed of copper to have a plate-like shape.

The pillar terminal 25 may include a pillar that may extend through the cap plate 31 and may have a top end thereof that may be inserted into the plate terminal 23, a flange externally that may protrude from a lower end of the pillar, and a step portion that may be formed between the flange and the pillar. The pillar terminal 25 may be formed of copper.

A sealing gasket 55 may be inserted and mounted in a hole through which the pillar terminal 25 may extend, between the pillar terminal 25 and the cap plate 31, and a lower insulation member 43 that may insulate the first terminal 21 and the current collecting tab 41 from the cap plate 31 may be internally mounted below the cap plate 31.

A short-circuit tab 53 may be mounted in the first terminal 21 and may be electrically connected thereto and mounted on the cap plate 31. An upper insulation member 54 may be mounted between the short-circuit tab 53 and the cap plate 31 and may electrically insulate the short-circuit tab 53 and the cap plate 31 from each other. The plate terminal 23 may be disposed at one side on the short-circuit tab 53, and a protecting cover 56 may be mounted at the other side on the short-circuit tab 53.

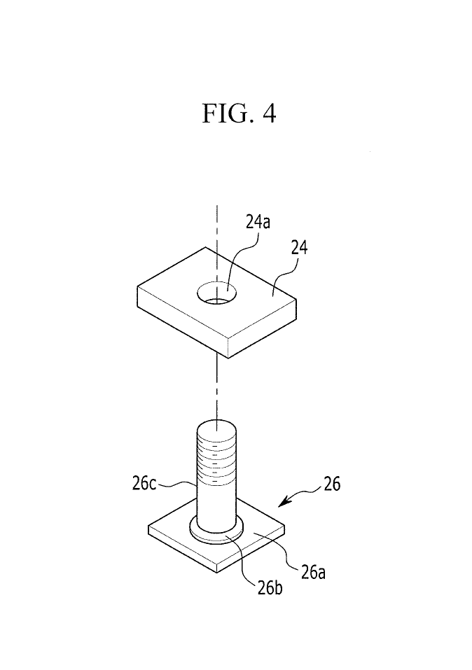

As shown in FIG. 4, the second terminal 22 may include a plate terminal 24 that may be exposed to the outside, and a pillar terminal 26. The plate terminal 24 may be formed to have a plate-like shape, and the pillar terminal 26 may be mounted to extend through the plate terminal 24. A through-hole 24a through which the pillar terminal 26 may be inserted may be formed at the center of the plate terminal 24, and the plate terminal 24 may be formed of an aluminum alloy.

The plate terminal 24 may be die-casted by a die-casting machine including a cold chamber. The plate terminal 24 may be formed of an aluminum alloy, and the aluminum alloy may contain 1.0 wt % or less of copper (Cu), 11.0-13.0 wt % of silicon (Si), 0.3 wt % or less of magnesium (Mg), 0.5 wt % or less of zinc (Zn), 1.3 wt % or less of iron (Fe), 0.3 wt % or less of manganese (Mn), 0.5 wt % or less of nickel (Ni), 0.30 wt % or less of titanium (Ti), 0.20 wt % or less of lead (Pb), and 0.1 wt % or less of tin (Sn), and a remaining part thereof includes aluminum (Al) and inevitable impurities.

Impact strength of the aluminum alloy may range from 75 to 84 kJ/m². For example, the impact strength of the aluminum alloy may be 79 kJ/m². Further, shear strength of the aluminum alloy may range from 160 to 180 MPa, and fatigue strength of the aluminum alloy may range from 120 to 140 MPa.

The plate terminal 24 may be die-casted, and may have a desired strength by using an aluminum alloy having the aforementioned composition. Further, die-casting the plate terminal 24 may help reduce manufacturing cost.

The pillar terminal 26 may include a pillar 26c that may extend through the cap plate 31 and may have a top end thereof that may be inserted into the plate terminal 24, a flange 26a that may externally protrude from a lower end of the pillar 26c, and a step portion 26b that may be formed between the flange 26a and the pillar 26c. The pillar terminal 26 may be formed of an aluminum alloy.

The step portion 26b may protrude from the flange 26a and may pressure on the gasket 55. A lower protrusion that may protrude downward and may be inserted into the current collecting tab 41 may be fixed by welding and may be formed on a bottom surface of the flange 26a. A screw thread may be formed at an upper portion of the pillar terminal 26, and the pillar terminal 26 may be manufactured by, e.g., using, a forging process or a drawing process.

A sealing gasket 65 may be inserted and mounted in a hole through which the pillar terminal 26 may extend, between the pillar terminal 26 and the cap plate 31, and a lower insulation member 45 that may insulate the pillar terminal 26 and the current collecting tab 42 from the cap plate 31 may be internally mounted below the cap plate 31. A connection plate 62 may be mounted between the plate terminal 24 and the cap plate 31 and may electrically connect the second terminal 22 and the cap plate 31 to each other.

The cap assembly 30 may include a short-circuit member 57 that may short-circuit the negative electrode 12 and the positive electrode 11. The short-circuit member 57 may be electrically connected to the cap plate 31, which may be electrically connected to the positive electrode 11, and may be connected to the short-circuit tab 53, which may be deformed when an internal pressure of the rechargeable battery 101 is increased, so that it may be electrically connected to the negative electrode 12.

A short-circuit hole 37 may be formed in the cap plate 31, and the short-circuit member 57 may be disposed in the short-circuit hole 37, between the upper insulation member 54 and the cap plate 31. The short-circuit member 57 may be formed to include an arc-shaped curved portion that is curved downward, and an inversion plate that may have a frame portion that may be fixed to the cap plate 31.

An upper hole 53a, which may be connected to the short-circuit hole 37 and disposed above the short-circuit member 57, may be formed in the short-circuit tab 53, and a reinforcing protrusion 53b may be formed at the circumference of the upper hole 53a and protrude downwardly. When the short-circuit tab 53 may contact the short-circuit member 57, the reinforcing protrusion 53b may contact the short-circuit member 57. Though an excessive current may flow through the short-circuit tab 53, contact of the protrusion 53b, which may be relatively thick, may help prevent stoppage of the short-circuit state that may be caused by melting of the short-circuit tab 37.

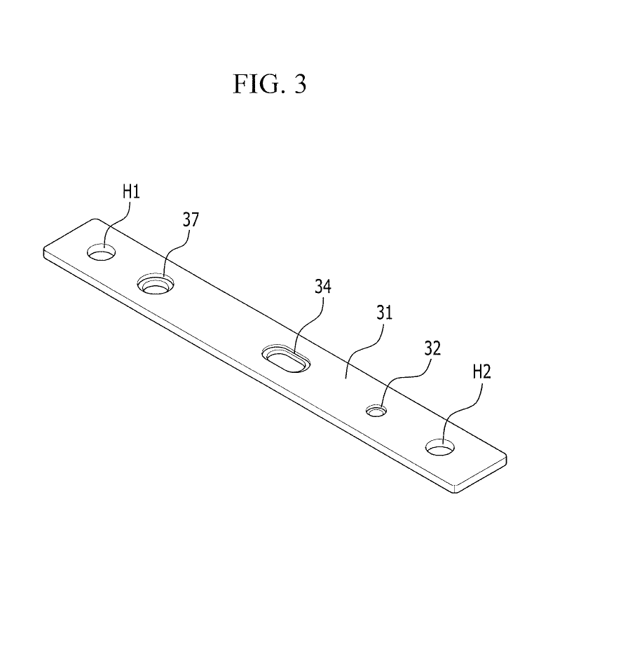

As shown in FIG. 3, the cap plate 31 may be formed to have a longitudinal plate-like shape that may extend in one direction, and may be connected to an opening of the case 27. Terminal holes H1 and H2 through which the pillar terminals 25 and 26 may respectively be inserted and an electrolyte injection opening for injecting an electrolyte solution may be formed in the cap plate 31. Further, a vent hole 34 and the short-circuit hole 37 may be formed in the cap plate 31. A sealing cap 38 may be inserted and mounted in an electrolyte injection opening 32, and a vent plate 39 in which a notch 39a may be formed may be mounted in the vent hole 34 and may be opened at a predetermined pressure.

The cap plate 31 may be die-casted by using an aluminum alloy. The aluminum alloy may contain 1.0 wt % or less of copper (Cu), 11.0-13.0 wt % of silicon (Si), 0.3 wt % or less of magnesium (Mg), 0.5 wt % or less of zinc (Zn), 1.3 wt % or less of iron (Fe), 0.3 wt % or less of manganese (Mn), 0.5 wt % or less of nickel (Ni), 0.30 wt % or less of titanium (Ti), 0.20 wt % or less of lead (Pb), and 0.1 wt % or less of tin (Sn), and a remaining part thereof includes aluminum (Al) and inevitable impurities.

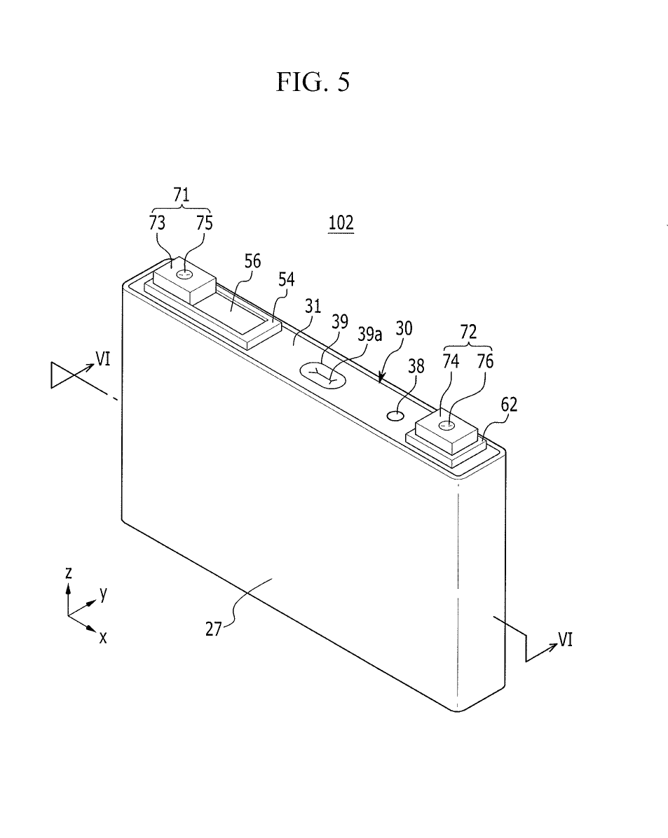

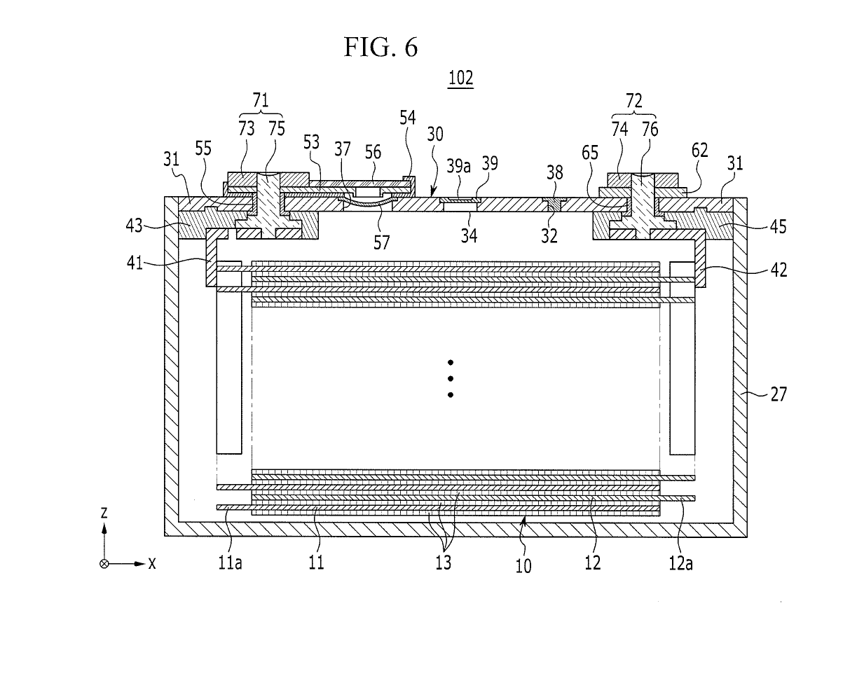

FIG. 5 is a perspective view showing a rechargeable battery according to a second exemplary embodiment, and FIG. 6 is a cross-sectional view taken along the line VI-VI of FIG. 5.

Referring to FIG. 5 and FIG. 6, the rechargeable battery 102 in accordance with a second exemplary embodiment may include an electrode assembly 10, a case 27 in which the electrode assembly 10 may be mounted, and a cap assembly 30 that may be coupled to an opening of the case.

The cap assembly 30 may include a cap plate 31 covering the opening of the case 27, a first terminal 71 protruding toward the outside of the cap plate 31 and electrically connected to the positive electrode 11, and a second terminal 72 protruding toward the outside of the cap plate 31 and electrically connected to the negative electrode 12.

The rechargeable battery of the second exemplary embodiment has the same structure as that of the rechargeable battery of the first exemplary embodiment except for structures of the first terminal 71 and the second terminal 72, and thus a repeated description of the same structure will be omitted.

The first terminal 71 and the second terminal 72 may be mounted to protrude toward an upper portion of the cap plate 31. The first terminal 71 may be electrically connected to the negative electrode 12 through a current collecting tab 41, and the second terminal 72 may be electrically connected to the positive electrode 11 through a current collecting tab 42.

The first terminal 71 may include a plate terminal 73 that may be exposed to the outside, and a pillar terminal 75 that may be disposed below the plate terminal 73 and adhered to the current collecting tab 41

The plate terminal 73 may be formed to have a plate-like shape, and the pillar terminal 75 may be inserted into the plate terminal 73 and may be fixedly mounted thereto. The plate terminal 73 and the pillar terminal 75 may be formed of copper.

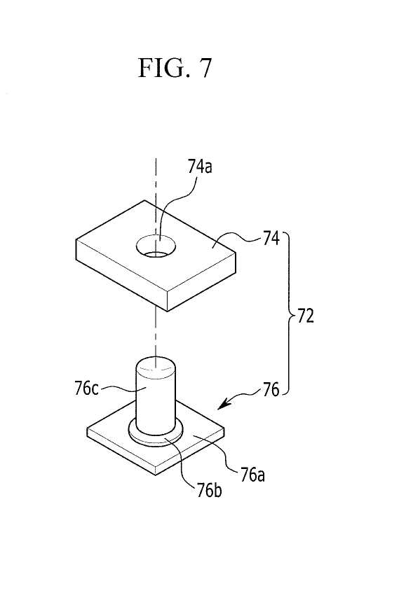

As shown in FIG. 7, the second terminal 72 may include a plate terminal 74 that may be exposed to the outside, and a pillar terminal 76. The plate terminal 74 may be formed to have a plate-like shape, and the pillar terminal 76 may be mounted, e.g., inserted, into the plate terminal 74. A through-hole 74a into which the pillar terminal 76 may be inserted may be formed at the center of the plate terminal 74, and the plate terminal 74 may be formed of an aluminum alloy.

The pillar terminal 26 may include a pillar 76c that may extend through the cap plate 31 and may have a top end thereof that may be inserted into the plate terminal 74, a flange 76a that may externally protrude from a lower end of the pillar 76c, and a step portion 76b that may be formed between the flange 76a and the pillar 76. The pillar terminal 76 may be formed of an aluminum alloy.

The pillar terminal 76 may be fixedly riveted to the plate terminal 74. Specifically, the pillar terminal 76 may be riveted to the plate terminal 74 by applying pressure to the upper portion of the pillar 76c that may be inserted into the plate terminal 74 and may be widely spread.

The plate terminal 74 and the pillar terminal 76 may be die-casted by a die-casting machine including a cold chamber. The plate terminal 74 and the pillar terminal 76 may be formed of an aluminum alloy, and the aluminum alloy may contain 1.0 wt % or less of copper (Cu), 11.0-13.0 wt % of silicon (Si), 0.3 wt % or less of magnesium (Mg), 0.5 wt % or less of zinc (Zn), 1.3 wt % or less of iron (Fe), 0.3 wt % or less of manganese (Mn), 0.5 wt % or less of nickel (Ni), 0.30 wt % or less of titanium (Ti), 0.20 wt % or less of lead (Pb), and 0.1 wt % or less of tin (Sn), and a remaining part thereof includes aluminum (Al) and inevitable impurities.

Impact strength of the aluminum alloy may range from 75 to 84 kJ/m². For example, the impact strength of the aluminum alloy may be 79 kJ/m². Further, shear strength of the aluminum alloy may range from 160 to 180 MPa, and fatigue strength of the aluminum alloy may range from 120 to 140 MPa.

By way of summation and review, a high power rechargeable battery may use a non-aqueous electrolyte with high energy density that may be formed as a large capacity rechargeable battery by connecting a plurality of rechargeable batteries in series, which may be used to drive a motor of a device, for example, an electric vehicle requiring a large amount of electric power.

Further, a large capacity rechargeable battery may be formed with a plurality of rechargeable batteries that may be coupled in series, and a rechargeable battery may be formed, for example, into a cylindrical shape or a square shape.

Components of the rechargeable battery may be forged since their shapes may be complex and it may be difficult to process the components. The components may also be manufactured by, e.g., using, a casting process, which may reduce manufacturing cost. However, the cast components may have low strength. In contrast, the components manufactured by, e.g., using, a forging process may have high strength, but manufacturing cost thereof may be increased.

Provided is a rechargeable battery that may be capable of reducing a manufacturing cost by being easily manufactured, that may be have a step portion, and which may have good strength.

According to an exemplary embodiment, it may be possible to die-cast a plate terminal to reduce a manufacturing cost thereof. Further, according to an exemplary embodiment, it may be possible to provide a rechargeable battery including a terminal that may have excellent strength.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

<Description of Symbols>

| | |
|---|---|
| 101, 102: rechargeable battery | 10: electrode assembly |
| 11: positive electrode | 12: negative electrode |
| 13: separator | 21, 71: first terminal |
| 22, 72: second terminal | 23, 24, 73, 74: plate terminal |
| 24a, 74a: through-hole | 25, 26, 75, 76: pillar terminal |
| 26a, 76a: flange | 26b, 76b: step portion |
| 26c, 76c: pillar | 27: case |
| 30: cap assembly | 31: cap plate |
| 41, 42: current collecting tab | 43, 45: lower insulation member |
| 53: short-circuit tab | 53a: upper hole |
| 53b: reinforcing protrusion | 54: upper insulation member |
| 55, 65: gasket | 56: protecting cap |
| 57: short-circuit member | 62: connection plate |

What is claimed is:

1. A rechargeable battery comprising:
an electrode assembly including a first electrode and a second electrode;
a case in which the electrode assembly is mounted;
a cap plate coupled to the case; and
a terminal electrically connected to the first electrode and protruding to an outside of the cap plate,
the terminal including a die-cast plate terminal and a pillar terminal inserted into the plate terminal, the plate terminal being formed of an aluminum alloy containing 1.0 wt % or less of copper (Cu), 11.0-13.0 wt % of silicon (Si), 0.3 wt % or less of magnesium (Mg), 0.5 wt % or less of zinc (Zn), 1.3 wt % or less of iron (Fe), 0.3 wt % or less of manganese (Mn), 0.5 wt % or less of nickel (Ni), 0.30 wt % or less of titanium (Ti), 0.20 wt % or less of lead (Pb), and 0.1 wt % or less of tin (Sn).

2. The rechargeable battery as claimed in claim 1, wherein a melting point of the aluminum alloy ranges from 573 to 582° C.

3. The rechargeable battery as claimed in claim 1, wherein an impact strength of the aluminum alloy ranges from 75 to 84 kJ/m².

4. The rechargeable battery as claimed in claim 1, wherein an impact strength of the aluminum alloy is 79 kJ/m².

5. The rechargeable battery as claimed in claim 1, wherein a shear strength of the aluminum alloy ranges from 160 to 180 MPa.

6. The rechargeable battery as claimed in claim 1, wherein a fatigue strength of the aluminum alloy ranges from 120 to 140 MPa.

7. The rechargeable battery as claimed in claim 1, wherein the cap plate is a die-cast cap plate.

8. The rechargeable battery as claimed in claim 7, wherein the cap plate is formed of an aluminum alloy containing 1.0 wt % or less copper (Cu), 11.0-13.0 wt % of silicon (Si), 0.3 wt % or less of magnesium (Mg), 0.5 wt % or less of zinc (Zn), 1.3 wt % or less of iron (Fe), 0.3 wt % or less of manganese (Mn), 0.5 wt % or less of nickel (Ni), 0.30 wt % or less of titanium (Ti), 0.20 wt % or less of lead (Pb), and 0.1 wt % or less of tin (Sn).

9. The rechargeable battery as claimed in claim 1, wherein a screw thread is formed at an upper portion of the pillar terminal, and the pillar terminal is manufactured by a drawing process.

10. The rechargeable battery as claimed in claim 1, wherein the pillar terminal is fixedly riveted to the plate terminal and is a die-cast pillar terminal.

11. The rechargeable battery as claimed in claim 10, wherein the pillar terminal is formed of an aluminum alloy containing 1.0 wt % or less of copper (Cu), 11.0-13.0 wt % of silicon (Si), 0.3 wt % or less of magnesium (Mg), 0.5 wt % or less of zinc (Zn), 1.3 wt % or less of iron (Fe), 0.3 wt % or less of manganese (Mn), 0.5 wt % or less of nickel (Ni), 0.30 wt % or less of titanium (Ti), 0.20 wt % or less of lead (Pb), and 0.1 wt % or less of tin (Sn).
